(19) United States
(12) Patent Application Publication
(10) Pub. No.: US 2007/0114304 A1
(43) Pub. Date: May 24, 2007

(54) Angular spray nozzle for gas dynamic spray machine

(76) Inventors: Lawrence J. Guc, Harrison Township, MI (US); Roman Gr. Maev, Windsor (CA); John M. Paille, Rochester Hills, MI (US); Emil E. Strumban, Oak Park, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/282,968

(22) Filed: Nov. 18, 2005

(51) Int. Cl. B05B 1/00

(52) U.S. Cl. 239/597; 239/601

(57) ABSTRACT

A nozzle extension for use with a nozzle of a particulate spray machine features a first substantially linear section terminating in a curvilinearly angled output section having a passageway with a diameter larger than a passageway in the linear section. The larger volume of the output section induces peripheral turbulence in the particulate flow to minimize clogging of the output passageway.

### FIELD OF THE INVENTION

The present invention relates to particulate spray guns. More specifically, the invention pertains to a nozzle extension for a supersonic particulate spray machine for conveying the high speed particles to a workpiece surface which is not disposed in the line of sight of the spray machine's normal output.

### BACKGROUND OF THE INVENTION

Supersonic gas dynamic spray (GDS) technology has proven highly efficient for applying dense coatings to various flat workpiece surfaces. There is a great demand in industry for cost effective application of such dense coatings on inside cylindrical surfaces of elements such as engine blocks, tubes, pipes and artillery gun barrels to enhance the wear resistance of components resident inside such cylindrical openings and to provide corrosion resistance to protect such surfaces from attack by materials flowing through the cylindrical passages of such elements. Applying the GDS technology to such cylindrical interior surfaces has presented problems in the past, because GDS is basically a line-of-sight process. Known angled extensions for GDS nozzles suffer from clogging problems which tend to manifest themselves in extremely short time periods, thereby substantially increasing the cost of arising from frequent required replacement.

Therefore there is seen to be a need in the art for a nozzle extension having an output angled away from the longitudinal center line of the output of the spray machine nozzle and capable of resisting clogging and maintaining the velocity of the accelerated particulates above a critical speed allowing for formation of dense coatings.

### SUMMARY OF THE INVENTION

A nozzle extension for use with a nozzle of a particulate spray machine includes a substantially linear hollow input section having an input end and an output end, the input end adapted to be coupled to the nozzle, the input section having a longitudinal axis and an input section inner diameter. A hollow curvilinearly angled output section of the extension has an input end coupled to the output end of the input section and an output end adapted for discharging particulate spray toward a workpiece surface. A longitudinal axis of the input end of the output section is substantially aligned with the longitudinal axis of the input section. The longitudinal axis of the output end of the output section extends at a non-zero angle to the longitudinal axis of the input section, and the output section has an output section interior diameter greater than the input section interior diameter.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 presents a partially cross sectioned side view of a nozzle extension arranged in accordance with the principles of the invention;

FIG. 2 sets forth perspective views of two different extension elements for a supersonic nozzle having different angled outputs, each arranged in accordance with the principles of the invention; and

FIG. 3 is a block diagram of a gas dynamic spray machine system suitable for use with the nozzle extension of the invention.

### DETAILED DESCRIPTION

Gas dynamic spraying uses a supersonic converging/diverging (de Laval-type) nozzle. A heated, high pressure carrier gas is supplied upstream of the converging portion of the nozzle and the powdered particulate material is introduced into the carrier gas stream in the nozzle. Coatings are produced by entraining metal powders in an accelerated air stream through a supersonic nozzle and projecting them against a target substrate, normally as close to a 90° angle as possible. It is believed that for the particulate matter to adhere to a substrate, they must break the oxide shell on the substrate material permitting subsequent metallurgical bond formation between plastically deformed particles and the substrate. It is imperative for the accelerated particles to exceed a critical velocity prior to their being able to bond successfully with the substrate.

One suitable form of gas dynamic spray system 300 is set forth in block diagram form in FIG. 3. Gas supply 310 creates a moving stream of carrier gas 316 which passes through a heater element 314 and enters a nozzle 302. Powder hoppers 304a and 304b are coupled to nozzle 302 via powder supply line 320. A pressure sensor 312 monitors pressure in supply line 320 and provides an indication thereof to a controller 308. Controller 308, in turn, has feedback control connections 324 to powder hoppers 304a and 304b. For applying the particulate matter to a workpiece surface or substrate which is not extending at substantially a right angle to the axis of the output of nozzle 302, an extension 100 arranged in accordance with the invention is utilized. The details of extension 100 will be set forth in a later section of this description.

Multiple powder hoppers 304a, b provide different desired powder compositions for different applications to powder inlet 318 of nozzle 302. Heater element 314 heats the gas to a temperature less than the melting point of the powder. Powder compositions from powder hoppers 304a and 304b are directed into nozzle 302 due to negative pressure created at the point of injection 318. The nozzle 302 propels the powder particles which are deposited atop a substrate as a bulk build-up of material.

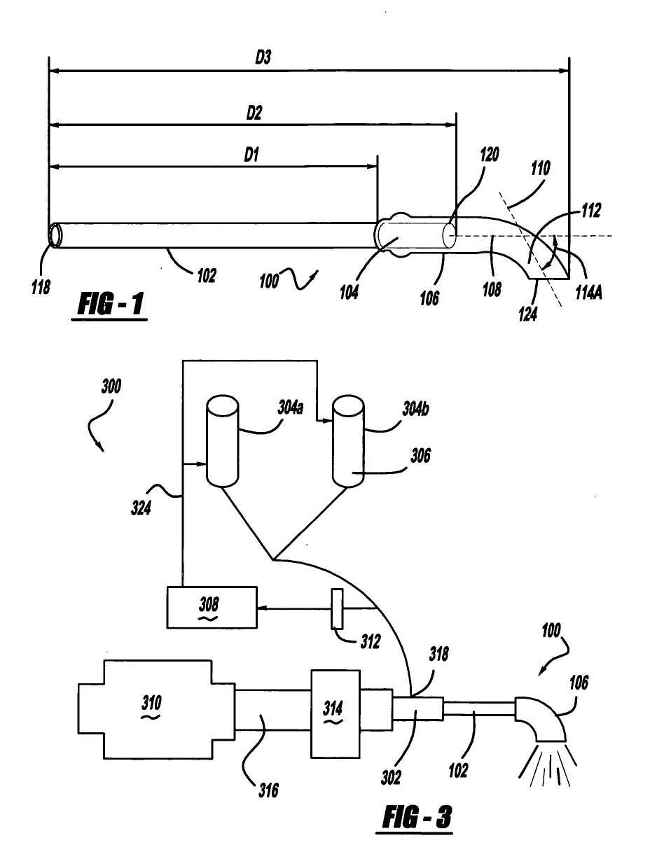

With reference to FIG. 1, details of an exemplary nozzle extension 100 are set forth. It is to be understood that such a nozzle can be used in any type of gas dynamic spray system—not just to the exemplary system 300 described above. Nozzle extension 100 has an input section 102 which extends substantially linearly along a longitudinal axis 108. Section 102 is hollow and has an inner diameter for passage of the particulate matter to be dispersed. Section 102 has an input end 118 adapted to be coupled to the output of a supersonic nozzle.

An output end 120 of input section 102 is in fluid communication with the interior of a curvilinear output section 106 of extension 100. The extension of FIG. 1 shows input section 102 being coupled to output section 106 via a threaded connection extending inside of section 106. However, it will be apparent to those skilled in the art that a variety of means could be utilized for coupling section 102 to 106, including forming the entire extension as a unitary piece.

Output section 106 has an input end with a longitudinal axis substantially aligned with axis 108 of the input section 102. Output section 106 has a longitudinal axis 110 at its output 124 which extends at a non-zero angle to axis 108. This angle A, or 114, is shown in FIG. 1 between axis 108 of input section 102 and axis 1 10 of the output end of output extension section 106.

The internal diameter of the hollowed portion of curvilinear section 106 is larger than that of input section 102. The resultant shape of the interior of section 106 induces peripheral turbulence in the particulate flow entering section 106 from output end 120 of section 102, thereby inhibiting adhesion of the particles to the interior surface of curvilinear section 106 as well as erosion of curvilinear section 106. Hence, clogging and erosion are minimized, or at least substantially delayed, with this design.

Angle A of FIG. 1 could range from just above 0° to about 90° where the output of the extension is substantially perpendicular to longitudinal axis 108. A more preferred range of angle A is between about 10° and about 80°.

As stated previously, the internal diameter of the hollow portion of section 106 is larger than the internal diameter of section 102. A preferred range of ratios of the internal diameter of section 106 to that of section 102 is between about 1.5 and about 3.5, more preferably between about 1.5 and about 3.0.

One specific extension as shown in FIG. 1 found to have very satisfactory performance utilizes an angle A of approximately 65°, an inside diameter of section 106 of 6.6 mm. and an inside diameter of section 102 of 3.55 mm. This yields a ratio of inner diameters on the order of 1.9. Additionally, section 102 of FIG. 1 has been found to operate satisfactorily where the length D1 of section 102 is 95 mm., the length D2 to the end of the screw coupled section at 120 is of 120 mm. and the overall longitudinal extent D3 of the nozzle extension 100 is 147 mm.

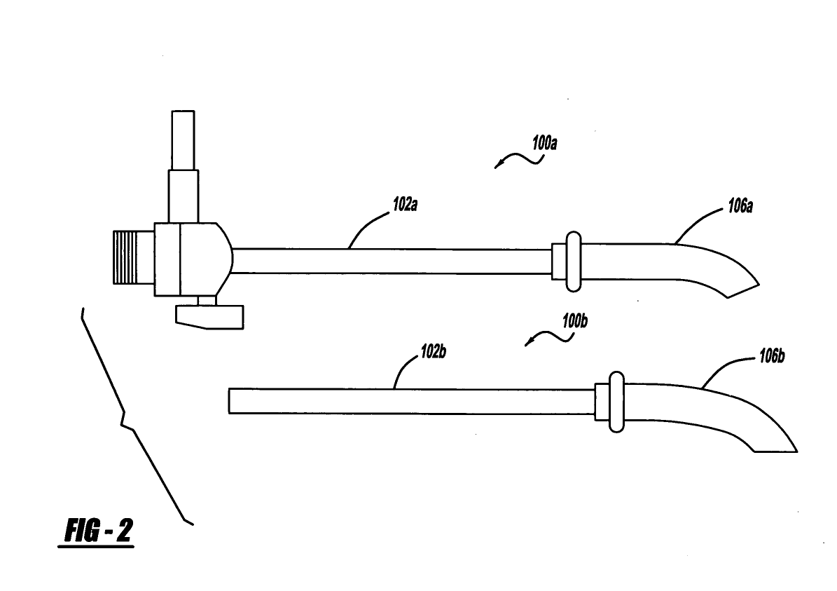

With reference to FIG. 2, two different angles A are shown in prototypes 100a and 100b.

Nozzle extension 100 can be fashioned from either metal or ceramics and, as mentioned above, may be comprised of a plurality of sections having means for joining the sections together or can be made as a single unitary piece. Each extension section can have a cylindrical, elliptical or polygonal internal opening carrying an inner liner of an abrasion resistant material for protecting the inner surface against abrasion by the particulate flow therethrough. The abrasion resistant inner liner should have an outer surface with a shape that corresponds and conforms to the inner surface of the extension section.

With the nozzle extension arranged as shown, it can be rotated about the axis of the supersonic nozzle outlet allowing formation of an even coating on surfaces being sprayed. Such an extension placed at the output of the spray gun nozzle enables spraying of internal surfaces of tubular-shaped parts with small diameter.

Due to the internal geometry of extension 100, the velocity of the accelerated particles above a critical speed is maintained, thereby allowing for a dense coating to be formed on a workpiece surface.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A nozzle extension for use with a nozzle of a particulate spray machine comprising:
a substantially linear hollow input section having an input end and an output end, the input end adapted to be coupled to the nozzle, the input section having a longitudinal axis and an input section inner diameter; and
a hollow curvilinearly angled output section having an input end coupled to the output end of the input section and an output end adapted for discharging particulate spray toward a workpiece surface, a longitudinal axis of the input end of the output section being substantially aligned with the longitudinal axis of the input section, the longitudinal axis of the output end of the output section extending at a non-zero angle to the longitudinal axis of the input section, and the output section having an output section inner diameter greater than the input section inner diameter.

2. The nozzle extension of claim 1 wherein a ratio of the output section inner diameter to the input section inner diameter is between about 1.5 and 3.5.

3. The nozzle extension of claim 1 wherein a ratio of the output section inner diameter to the input section inner diameter is between about 1.5 and 3.0.

4. The nozzle extension of claim 1 wherein a ratio of the output section inner diameter to the input section inner diameter is on the order of 1.9.

5. The nozzle extension of claim 1 wherein the inner diameter of the output section is greater than the inner diameter of the input section by an amount sufficient to cause peripheral turbulence in particulate flow entering the output section, thereby inhibiting deposits of particulate matter on an interior surface of the output section.

6. The nozzle extension of claim 1 wherein the non-zero angle is about equal to or less than 90°.

7. The nozzle extension of claim 1 wherein the non-zero angle is between about 10° and about 80°.

8. The nozzle extension of claim 2 wherein the non-zero angle is about equal to or less than 90°.

9. The nozzle extension of claim 3 wherein the non-zero angle is about equal to or less than 90°.

10. The nozzle extension of claim 4 wherein the non-zero angle is about equal to or less than 90°.

11. The nozzle extension of claim 2 wherein the non-zero angle is between about 10° and about 80°.

12. The nozzle extension of claim 3 wherein the non-zero angle is between about 10° and about 80°.

13. The nozzle extension of claim 4 wherein the nozzle angle is between about 10° and about 80°.

14. The nozzle extension of claim 1 wherein the non-zero angle provides a direction and pattern to sprayed particulate matter exiting the output end of the output section enabling optimized adherence of the particulate matter to a workpiece surface.

15. The nozzle extension of claim 5 wherein the non-zero angle provides a direction and pattern to sprayed particulate matter exiting the output end of the output section enabling optimized adherence of the particulate matter to a workpiece surface.
